(19) United States
(12) Patent Application Publication
(10) Pub. No.: US 2015/0028274 A1
(43) Pub. Date: Jan. 29, 2015

(54) ASSEMBLY AND METHOD FOR ASSEMBLING A CABLE PULLER

(71) Applicant: Darrell D. Dugger, Grafton, IL (US)

(72) Inventor: Darrell D. Dugger, Grafton, IL (US)

(21) Appl. No.: 13/953,461

(22) Filed: Jul. 29, 2013

(51) Int. Cl. H02G 1/08

(52) U.S. Cl. CPC H02G 1/08
USPC 254/134.3 FT

(57) ABSTRACT

A cable puller assembly is provided. The cable puller assembly includes a gripping assembly including a first engaging member and a second engaging member removably coupled to the first engaging member, the gripping assembly further including an assembly interior surface at least partially defining a cable channel configured to receive a cable. The cable puller assembly further includes a plurality of friction elements disposed on the assembly interior surface, a cable support member coupled to the gripping assembly, the cable support member configured to guide the cable through the cable channel, and a pulling member coupled to the gripping assembly.

### BACKGROUND OF THE DISCLOSURE

The field of the disclosure relates generally to a cable puller and, more specifically, to a cable puller that reduces the risk of damage to a cable during use.

In some applications, a cable puller may be used to couple a cable to a pulling device (e.g., a crane, winch, etc.) when directly coupling the device to the cable may be undesirable. For example, pulling a steel cable using a crane may risk damage to the cable.

### BRIEF DESCRIPTION OF THE DISCLOSURE

In one aspect, a cable puller assembly is provided. The cable puller assembly includes a gripping assembly including a first engaging member and a second engaging member removably coupled to the first engaging member, the gripping assembly further including an assembly interior surface at least partially defining a cable channel configured to receive a cable. The cable puller assembly further includes a plurality of friction elements disposed on the assembly interior surface, a cable support member coupled to the gripping assembly and configured to guide the cable through the cable channel, and a pulling member coupled to the gripping assembly.

In another aspect, a method of assembling a cable puller assembly is provided. The method includes providing a gripping assembly that includes a first engaging member and a second engaging member that is removably coupled to the first engaging member. The gripping assembly further including an assembly interior surface at least partially defining a cable channel configured to receive a cable. The method further includes disposing a plurality of friction elements on the assembly interior surface. The method also includes coupling a cable support member to the gripping assembly, wherein the cable support member is configured to guide the cable through the cable channel, and coupling a pulling member to the gripping assembly.

### BRIEF DESCRIPTION OF THE DRAWINGS

FIG. 1 is a perspective view of a cable puller assembly in accordance with one embodiment of the disclosure;

FIG. 2 is a front view of the cable puller assembly shown in FIG. 1;

FIG. 3 is a schematic view of a first engaging member of the cable puller assembly shown in FIG. 1;

FIG. 4 is a schematic view of a second engaging member of the cable puller assembly shown in FIG. 1;

FIG. 5 is a perspective view of the cable puller assembly shown in FIG. 1 attached to a cable; and

FIG. 6 is a flow diagram of a method for assembling a cable puller assembly in accordance with one embodiment of the disclosure.

### DETAILED DESCRIPTION OF THE DISCLOSURE

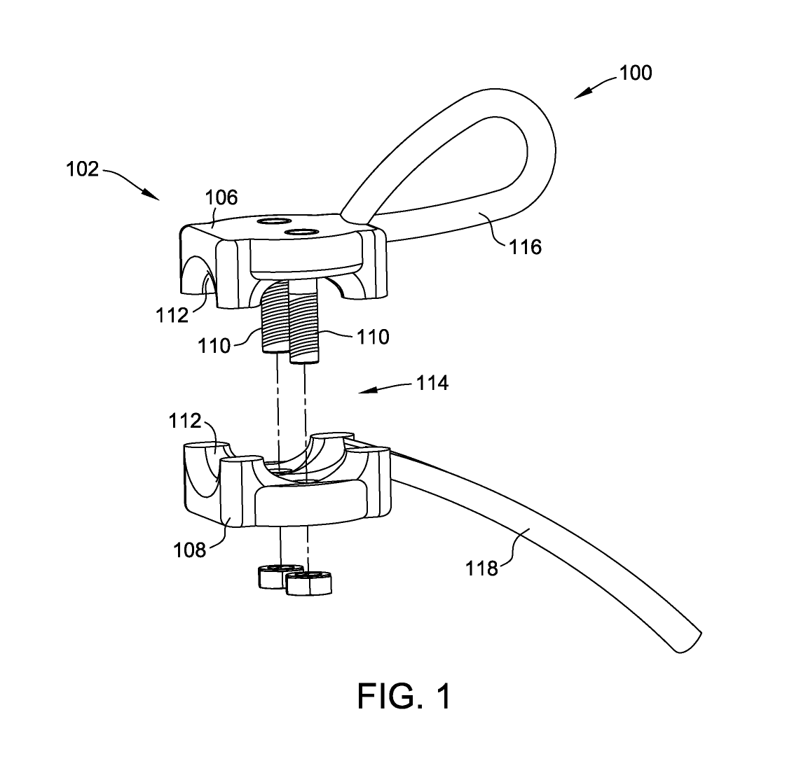

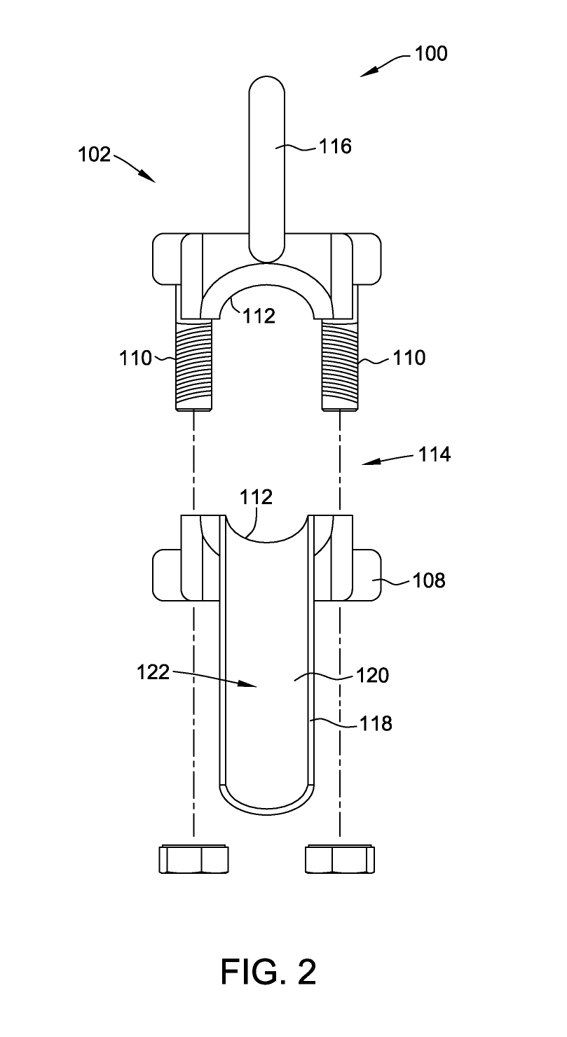

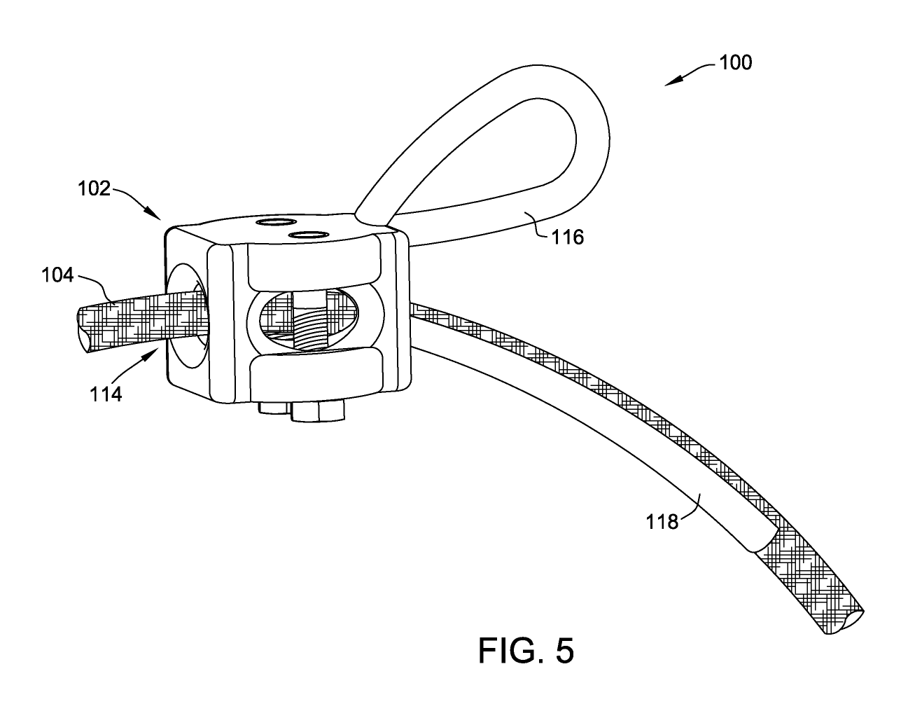

FIG. 1 is a perspective view of a cable puller assembly 100 in accordance with one embodiment of the disclosure. FIG. 2 is a front view of cable puller assembly 100 shown in FIG. 1. Cable puller assembly 100 includes a gripping assembly 102 configured to couple cable puller assembly 100 with a cable 104 (shown in FIG. 5). Gripping assembly 102 includes a first engaging member 106 removably coupled to a second engaging member 108 using at least one threaded connector 110. Gripping assembly 102 also includes an assembly interior surface 112 which at least partially defines a cable channel 114 configured to receive cable 104. In the exemplary embodiment, cable channel 114 is a substantially cylindrical channel that extends through gripping assembly 102. Assembly interior surface 112 is configured such that a width of cable channel 114 is substantially similar to a width of cable 104. Alternatively, assembly interior surface 112 is configured such that a width of cable channel 114 is any width that enables operation of cable puller assembly 100 as described herein.

Cable puller assembly 100 also includes a pulling member 116 that is configured to connect with a pulling means. Pulling member 116 extends from first engaging member 106 of gripping assembly 102. In the exemplary embodiment, pulling member 116 forms a connector, such as a loop, hook, or notch. During use, a pulling means (not shown) is connected to pulling member 116 to pull cable 104 with cable puller assembly 100. In some embodiments, the pulling means is a crane or other device capable of lifting, pulling, or attaching to a cable.

Cable puller assembly 100 further includes a cable support member 118 that is configured to support cable 104 when pulled. Cable support member 118 extends from second engaging member 108 of gripping assembly 102 in a curved configuration. In one embodiment, the curved configuration has a radius of curvature sufficient to prevent damage to cable 104. In the exemplary embodiment, cable support member 118 includes a support interior surface 120 that defines a support cable channel 122. In the exemplary embodiment, support cable channel 122 is substantially similar to cable channel 114. More specifically, cable channel 114 extends from gripping assembly 102 through cable support member 118. During use, cable 104 is received by cable channel 114 then secured by gripping assembly 102 and supported by cable support member 118 when pulled by a pulling means connected to pulling member 116.

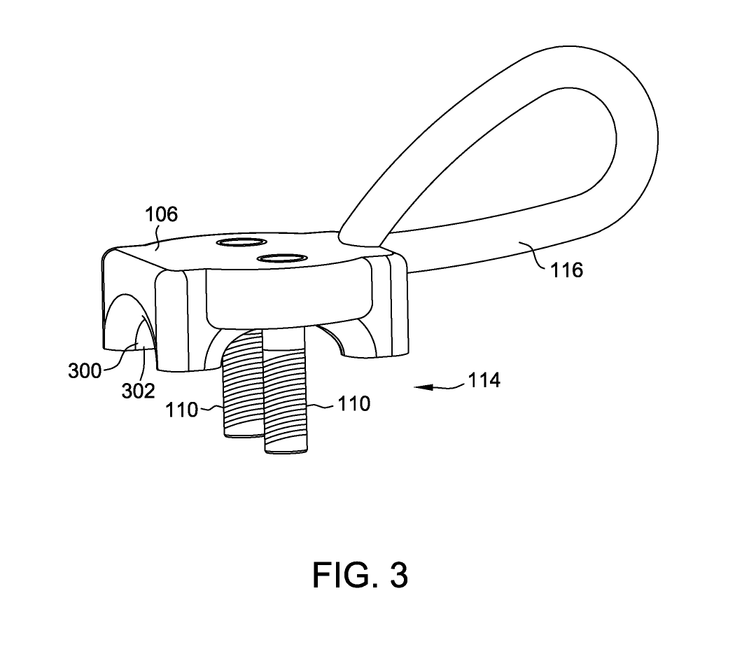

FIG. 3 is a schematic view of first engaging member 106 of cable puller assembly 100 (shown in FIGS. 1 and 2). First engaging member 106 includes a first interior surface 300 that at least partially defines assembly interior surface 112 (shown in FIGS. 1 and 2) and cable channel 114. In the exemplary embodiment, first interior surface 300 defines a pair of perpendicular, u-shaped channels (not shown) extending through first engaging member 106 where one of the u-shaped channels at least partially forms cable channel 114.

First engaging member 106 also includes a plurality of first friction elements 302 disposed on first interior surface 300. In the exemplary embodiment, friction elements 302 are ridges or grooves on surface 300 and are configured to mate with a surface of cable 104 (shown in FIG. 5). During use, friction elements 302 reduce movement of cable 104 through cable channel 114. In alternate embodiments, friction elements 302 are any combination of shapes, or textures, disposed on surface 300 that enables operation of cable puller assembly 100 as described herein.

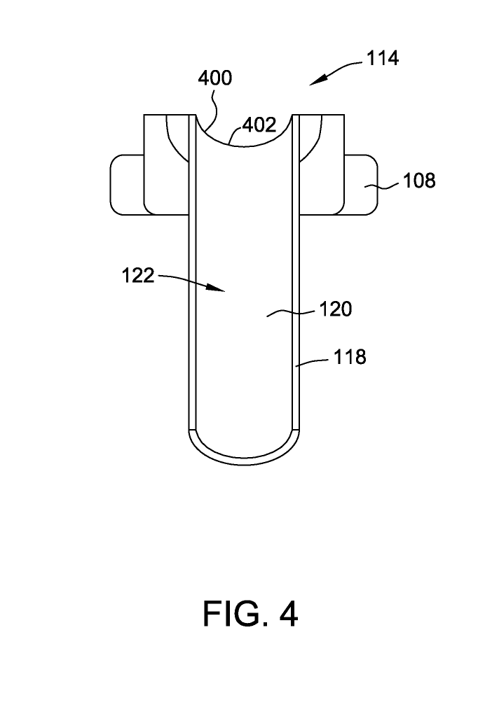

First engaging member 106 further includes at least one threaded connector 110 configured to removably couple first engaging member 106 to second engaging member 108. In the exemplary embodiment, first engaging member 106 includes two threaded connectors 110 extending from first engaging member 106 on either side of cable channel 114. Further, in the exemplary embodiment, each threaded connector 110 is a bolt or screw. Alternatively, threaded connector 110 is any threaded fastener configurable to removably couple first engaging member 106 to second engaging member 108 (shown in FIG. 4).

FIG. 4 is a schematic view of second engaging member 108 of cable puller assembly 100 (shown in FIGS. 1 and 2). Second engaging member 108 includes a second interior surface 400. In the exemplary embodiment, second interior surface 400 is substantially similar to first interior surface 300 (shown in FIG. 3). Moreover, second interior surface 400 is configured to cooperate with first interior surface 300 to define assembly interior surface 112 and cable channel 114 (shown in FIGS. 1 and 2).

Second engaging member 108 also includes a plurality of second friction elements 402 disposed on second interior surface 400. In the exemplary embodiment, friction elements 402 are ridges or grooves on surface 400 and are configured to mate with a surface of cable 104 (shown in FIG. 5). During use, friction elements 402 reduce movement of cable 104 through cable channel 114. In the exemplary embodiment, friction elements 402 are configured to cooperate with friction elements 302 (shown in FIG. 3) to reduce movement of cable 104 through cable channel 114.

FIG. 5 is a perspective view of cable puller assembly 100 attached to cable 104. As shown in FIG. 5, cable 104 is received in cable channel 114 and is coupled to cable puller assembly 100 by gripping assembly 102 and supported by cable support member 118. During use, a pulling means (not shown) is connected to pulling member 116 and used to pull cable 104.

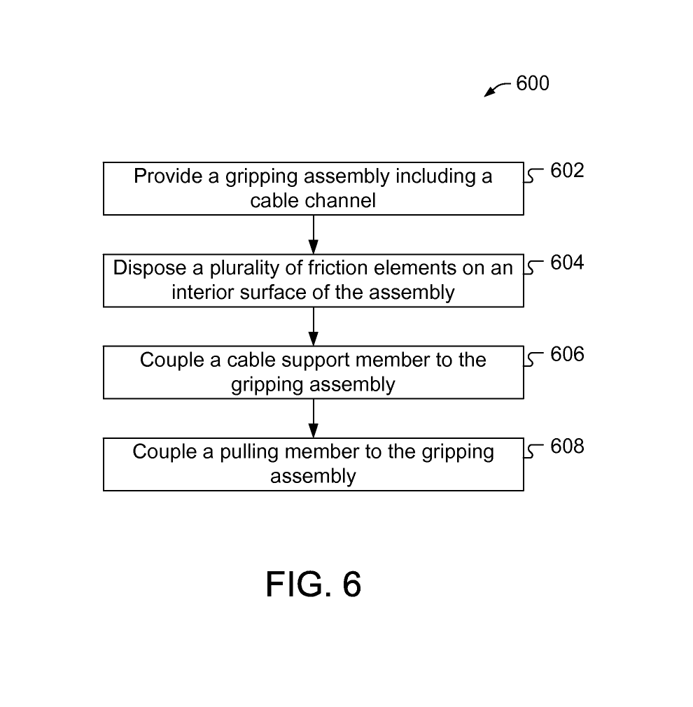

FIG. 6 is a flow diagram of a method 600 for assembling a cable puller assembly, such as cable puller assembly 100, in accordance with one embodiment of the disclosure.

During operation, method 600 includes providing 602 a gripping assembly, such as gripping assembly 102, that includes a first engaging member, such as first engaging member 106, and a second engaging member, such as second engaging member 108, that is removably coupled to the first engaging member. The gripping assembly further includes an assembly interior surface, such as assembly interior surface 112, at least partially defining a cable channel, such as cable channel 114, that is configured to receive a cable. In the exemplary embodiment, the first engaging member is removably coupled to the second engaging member using a threaded connector, such as threaded connector 110.

Method 600 further includes disposing 604 a plurality of friction elements on the assembly interior surface. The plurality of friction elements are configured to reduce movement of the cable in the gripping assembly during use of the cable puller assembly. In the exemplary embodiment, the plurality of friction elements includes a plurality of first friction elements, such as friction elements 302, disposed on the first interior surface of the first engaging member and a plurality of second friction elements, such as friction elements 402, disposed on the second interior surface of the second engaging member.

Method 600 also includes coupling 606 a cable support member, such as cable support member 118, to the gripping assembly. The cable support member is configured to support the cable during use of the cable puller assembly. More specifically, the cable support member is configured to support the cable so that the risk of damaging the cable is reduced. In the exemplary embodiment, the cable support member extends from the second engaging member of the gripping assembly in a curved configuration.

Method 600 further includes coupling 608 a pulling member, such as pulling member 116, to the gripping assembly. The pulling member is used to connect a pulling means to the cable puller assembly. In the exemplary embodiment, the pulling member extends from the first engaging member of the gripping assembly.

The assembly and method as described herein facilitate providing a cable puller assembly. Specifically, the assembly and method as described above facilitate providing a cable puller assembly that may be used to pull a cable and that reduces the risk of damaging a cable when pulled.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A cable puller assembly comprising:
a gripping assembly including a first engaging member and a second engaging member removably coupled to said first engaging member, said gripping assembly further including an assembly interior surface at least partially defining a cable channel configured to receive a cable;
a plurality of friction elements disposed on said assembly interior surface;
a cable support member coupled to said gripping assembly, said cable support member configured to guide the cable through said cable channel; and
a pulling member coupled to said gripping assembly.

2. The cable puller assembly in accordance with claim 1 wherein said first engaging member comprises a first interior surface and said second engaging member comprises a second interior surface, said first interior surface and said second interior surface defining said assembly interior surface.

3. The cable puller assembly in accordance with claim 2 wherein said plurality of friction elements includes a plurality of first friction elements disposed on said first interior surface and a plurality of second friction elements disposed on said second interior surface.

4. The cable puller assembly in accordance with claim 1 wherein said cable channel extends from said gripping assembly through said cable support member.

5. The cable puller assembly in accordance with claim 1 wherein said cable support member comprises a support interior surface at least partially defining a support cable channel that is substantially similar to said cable channel.

6. The cable puller assembly in accordance with claim 1 wherein said cable support member comprises a profile that is substantially arcuate.

7. The cable puller assembly in accordance with claim 1 wherein said cable support member comprises a cross-section that is substantially semi-circular.

8. The cable puller assembly in accordance with claim 1 wherein said cable support member is coupled to said second engaging member.

9. The cable puller assembly in accordance with claim 1 wherein said pulling member is coupled to said first engaging member.

10. The cable puller assembly in accordance with claim 1 wherein said first engaging member is removably coupled to said second engaging member using at least one threaded connector.

11. A method of assembling a cable puller assembly, said method comprising:
providing a gripping assembly that includes a first engaging member and a second engaging member that is removably coupled to the first engaging member, the gripping assembly further including an assembly interior surface at least partially defining a cable channel configured to receive a cable;
disposing a plurality of friction elements on the assembly interior surface;
coupling a cable support member to the gripping assembly, the cable support member configured to guide the cable through the cable channel; and
coupling a pulling member to the gripping assembly.

12. The method for assembling a cable puller assembly in accordance with claim 11 wherein the first engaging member comprises a first interior surface and the second engaging member comprises a second interior surface, the first interior surface and the second interior surface defining the assembly interior surface.

13. The method for assembling a cable puller assembly in accordance with claim 12 wherein the plurality of friction elements includes a plurality of first friction elements disposed on the first interior surface and a plurality of second friction elements disposed on the second interior surface.

14. The method for assembling a cable puller assembly in accordance with claim 11 wherein the cable channel extends from the gripping assembly through the cable support member.

15. The method for assembling a cable puller assembly in accordance with claim 11 wherein the cable support member comprises a support interior surface at least partially defining a support cable channel that is substantially similar to the cable channel.

16. The method for assembling a cable puller assembly in accordance with claim 11 wherein the cable support member comprises a profile that is substantially arcuate.

17. The method for assembling a cable puller assembly in accordance with claim 11 wherein the cable support member comprises a cross-section that is substantially semi-circular.

18. The method for assembling a cable puller assembly in accordance with claim 11 wherein the cable support member is coupled to the second engaging member.

19. The method for assembling a cable puller assembly in accordance with claim 11 wherein the pulling member is coupled to the first engaging member.

20. The method for assembling a cable puller assembly in accordance with claim 11 wherein the first engaging member is removably coupled to the second engaging member using at least one threaded connector.
